(19) United States
(12) Patent Application Publication
(10) Pub. No.: US 2016/0129609 A1
(43) Pub. Date: May 12, 2016

(54) TABLE TOP FOR MATERIAL SHAPING MACHINE AND METHOD OF MOUNTING THEREOF

(71) Applicant: Park Industries, Inc., St. Cloud, MN (US)

(72) Inventor: Michael M. Czeck, Rice, MN (US)

(21) Appl. No.: 14/823,544

(22) Filed: Aug. 11, 2015

Related U.S. Application Data
(63) Continuation of application No. 14/178,508, filed on Feb. 12, 2014, now abandoned.
Application No. 14/178,508 is a continuation of application No. 12/763,031, filed on Apr. 19, 2010, now abandoned.
(60) Provisional application No. 61/170,434, filed on Apr. 17, 2009.

(51) Int. Cl. B28D 1/18; B28D 7/04; B28D 1/00; B23Q 1/03; B23Q 1/01

(52) U.S. Cl. CPC B28D 1/18; B23Q 1/032; B23Q 1/015; B28D 1/003; B28D 7/04

(57) ABSTRACT

A material shaping machine and a method of mounting a table top to the material shaping machine is disclosed. The machine includes first and second support members extending generally in a vertical direction. A bridge longitudinally extends between the first and the second support members. A carriage is configured to move longitudinally along the bridge. A rotary cutting tool is mounted on the carriage. A work table including a table top having a silicon/epoxy combination material supports a workpiece to be cut by the cutting tool. An actuator moves the rotary cutting tool toward and away from the workpiece positioned on or above the table top and a motor provides rotational motion to the rotary cutting tool.

### CROSS REFERENCE TO RELATED APPLICATION(S)

This application is a continuation of U.S. patent application Ser. No. 14/178,508, filed Feb. 12, 2014, which is a continuation of U.S. patent application Ser. No. 12/763,031, filed Apr. 19, 2010, which claims priority to U.S. Provisional Application Ser. No. 61/170,434, filed Apr. 17, 2009, which applications are incorporated herein by reference in their entirety.

### TECHNICAL FIELD

The present disclosure relates generally to machines for cutting/shaping various materials including stone and other materials. More particularly, the present disclosure relates to materials for table tops for use on such machines and a method of mounting the table tops to the machines.

### BACKGROUND

Various machines such as CNC router machines for cutting or shaping stone and similar materials are known in the art. Workpieces to be fabricated are placed on work tables of the machines and any number of predetermined cutting/routing operations are carried out. The table top material used for the work tables of such machines has to be carefully selected and requires a number of specific characteristics.

The cutting/routing operations provide for a harsh environment resulting in a lot of debris and water. Depending upon the water source used for the supply water for the cutting/routing operation, the pH level and the alkalinity of the water can vary. Certain supply water might also include a lot of additives such as chlorine and other chemicals. Thus, the table top material needs to display characteristics such as high corrosion resistance and low oxidation.

Low thermal expansion is another characteristic desired for the table top material. Changes in temperature can, otherwise, result in distortion of the table top and misalignment of the parts during fabrication.

Durability and impact resistance are also important for the table top material, especially in heavy stone fabrication applications. If a workpiece such as a heavy piece of stone is dropped on the table top, significant damage is likely to occur. It would be desirable to prevent dents, scratches, and dings. However, if damage were to occur, it would be desirable to provide a table top material that is easily repairable in the field and that does not require replacement of the entire top.

Furthermore, it is also desirable to provide a material that has a high static coefficient of friction to prevent unwanted movement/slippage of the workpieces or other workpiece holding structures that are in contact with the table top. In addition to a high static coefficient of friction, however, a smooth table top surface is also very important. For providing stability to the workpieces during the shaping process, various clamping techniques have been utilized on these machines. One known clamping arrangement includes the use of vacuum clamps. Vacuum clamps normally have two vacuum connections. A vacuum applied to a first connection fixes the vacuum clamp on the machine work table to prevent it from moving during the handling of the workpiece. A vacuum applied to a second connection clamps the workpiece to the vacuum clamp. Such vacuum clamps having hose connections are designed for universal use on CNC machines and tools. However, a smooth table top is necessary for proper operation of such clamps. An even surface lacking voids or imperfections and a high coefficient of friction are desired properties for table tops utilizing vacuum clamps. The holding forces produced by a vacuum clamp can reduce damage to the workpiece during fabrication and provide for high precision cuts.

The attributes listed, including the combination of a high static coefficient of friction and a smooth surface, significantly narrow the number of choices available for table top materials. In various prior art vacuum tables, materials such as granite have been used for the table tops. Those preferring lighter weight alternatives have turned to materials such as PVC polymer or aluminum. PVC polymers have proved dissatisfactory due to their high coefficient of thermal expansion. Certain types of aluminum such as K-100 Aluminum have also displayed undesired characteristics such as low corrosion resistance and rapid oxidation, making them less durable in aqueous environments. Certain types of aluminum may corrode or oxidize depending on the pH and alkalinity of the water source. K-100 Aluminum has been known to rapidly oxidize when exposed to highly chlorinated water. Other types of aluminum such as K-100S Aluminum have proved satisfactory in most applications but still lack the high impact resistance desired in most heavy stone fabrication applications. Since metal materials such as aluminum are not resistant to denting, if a workpiece such as a heavy piece of stone is dropped on the table top, significant damage is likely to occur. Scratches and dings are also difficult to repair on metal table tops and may require replacement of the table top.

Improvements and alternatives in table top materials for use in cutting/shaping machines such as CNC routing machines are desired. Reliable and simple techniques for mounting such table top materials to work tables are also desired.

### SUMMARY

One aspect of the present disclosure relates to a novel table top material for use on machines for cutting/shaping various materials including stone and other materials, such machines including CNC routing machines.

Another aspect of the present disclosure relates to a method of mounting the table top material to a work table of the machine such as a CNC routing machine.

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

The accompanying drawings are included to provide a further understanding of the inventive aspects of the present disclosure and are incorporated in and constitute a part of this specification. The drawings illustrate exemplary embodiments of the present disclosure and together with the description serve to further explain the principles of the disclosure. Other aspects of the present disclosure and many of the advantages of the present disclosure will be readily appreciated as the present disclosure becomes better understood by reference to the following Detailed Description when considered in connection with the accompanying drawings, and wherein:

FIG. 1 is a side view of a material shaping machine such as a CNC routing machine including a table top having features that are examples of inventive aspects in accordance with the principles of the present disclosure;

FIG. 2 is a top view of the machine of FIG. 1;

FIG. 3 is a front view of the machine of FIG. 1;

FIG. 4 is a perspective view of a work table for use with the machine of FIG. 1, the work table including a table top having features that are examples of inventive aspects in accordance with the principles of the present disclosure;

FIG. 5 is a top view of the work table of FIG. 4;

FIG. 6 is a front view of the work table of FIG. 4;

FIG. 7 is a cross-sectional view of a portion of the work table of FIGS. 4-6, taken along line 7-7 of FIG. 5, the cross-sectional view illustrating an example mounting method for mounting the table top to the work table shown in FIGS. 4-6, the mounting method having features that are examples of inventive aspects in accordance with the principles of the present disclosure; and

FIG. 8 illustrates an example Pull Test performed to test the static coefficient of friction of various table top materials.

### DETAILED DESCRIPTION

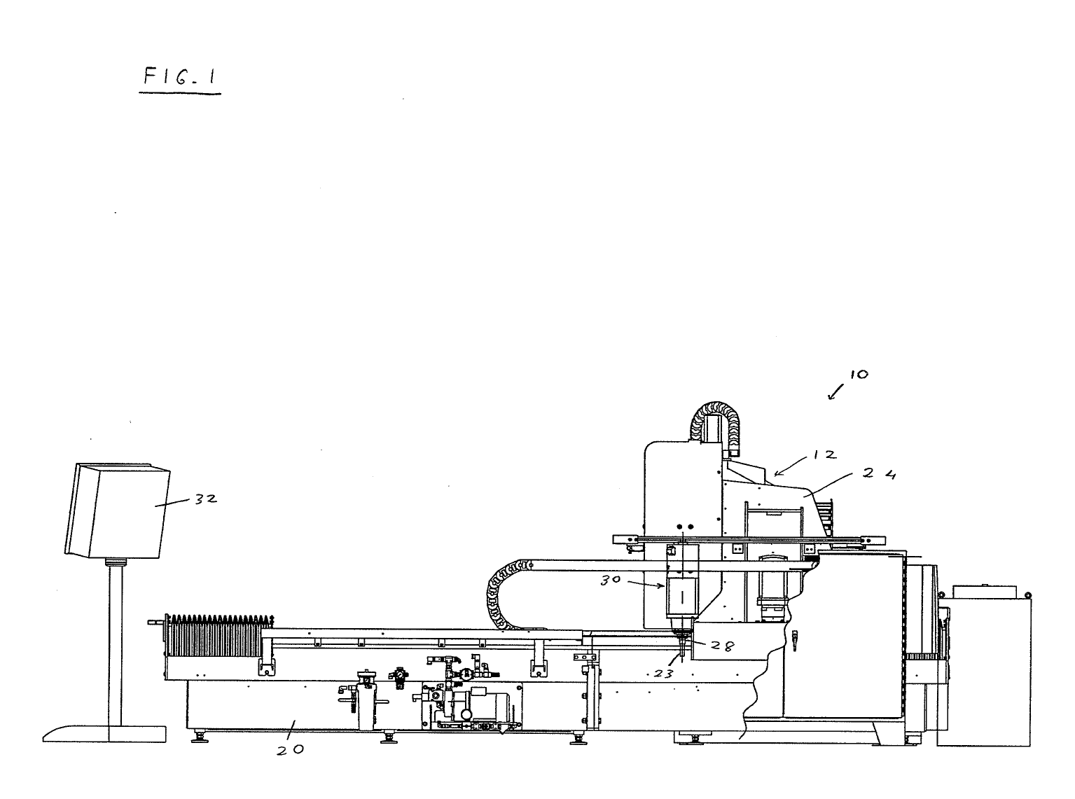

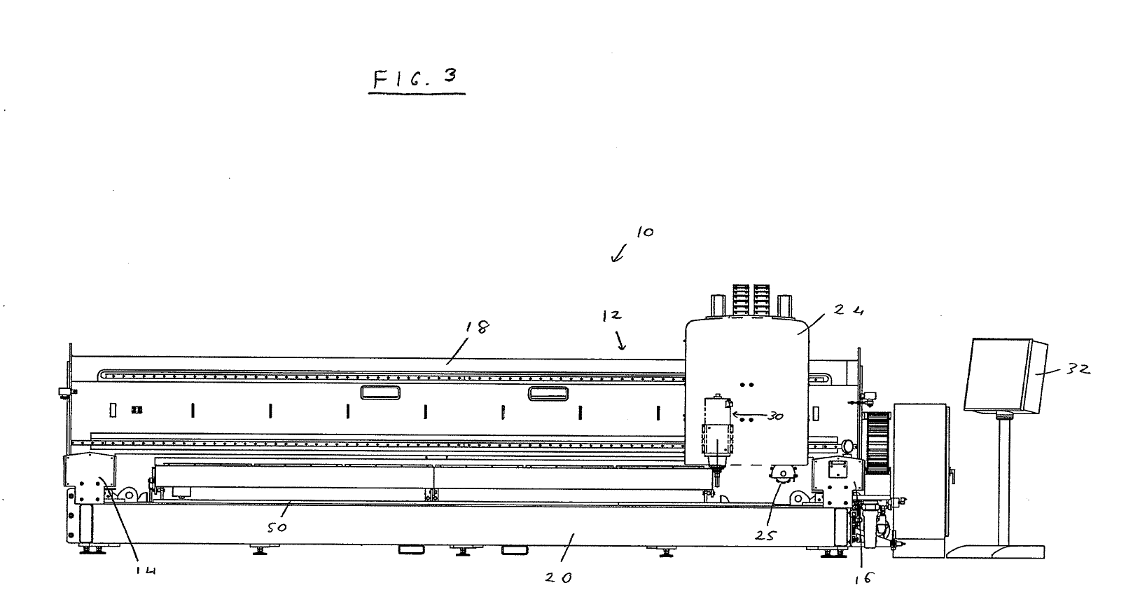

FIGS. 1-3 illustrate a material shaping machine 10 in accordance with the principles of the present disclosure. In the example of FIGS. 1-3, the material shaping machine 10 is depicted as a CNC routing machine. A CNC routing machine having features similar to the machine 10 shown in FIGS. 1-3 is available from Park Industries, Inc., under the model line “Titan™”. The machine 10 depicted herein may be used to shape workpieces of stone, granite, and other materials.

Referring to FIGS. 1-3, the CNC routing machine 10 includes a gantry assembly 12 including a first support member 14, a second support member 16 and a bridge 18 extending longitudinally therebetween. The bridge 18 is configured to move transversely along the support members 14, 16 with respect to a work table 20. The movement of the bridge 18 may be accomplished through rail members 22 on the first and second support members 14, 16.

It should be noted that, although the CNC routing machine 10 is depicted as a gantry-type material shaping machine, the inventive aspects of the disclosure also apply to other types of machines.

Still referring to FIGS. 1-3, the bridge 18 has mounted thereon a motor-driven carriage 24 including a router 23 and a rotary cutting blade 25. The carriage 24 is configured to move longitudinally with respect to the bridge 18 over the work table 20, in a direction perpendicular to the direction of the movement of the bridge 18 with respect to the first and second support members 14, 16. The carriage 24 depicted is known in the art, being of the type used in conventional numerically controlled or non-numerically controlled, manual material shaping machines.

Still referring to FIGS. 1-3, the rotary cutting blade 25 is connected to a motor for bringing the cutting blade 25 into rotational motion. The rotary routing tool 23 is also connected via a spindle 28 to a motor for bringing the tool 23 into rotational motion. The cutting blade 25 and the routing tool 23 are operatively connected to a vertical travel assembly 30 of the carriage 24. The vertical travel assembly 30 includes an actuator configured to move the cutting blade 25 and/or the routing tool 23 toward and away from a workpiece positioned on the work table 20.

As shown in FIGS. 1-3, the machine 10 may include a control station 32. The control station 32 includes a host of input/output devices for operator control, and an internally disposed microprocessor having a memory and a controller. The memory is provided for storing data representing any number of predetermined cutting/routing operations. The controller may be communicatively coupled to the rest of the machine 10 for selectively controlling any number of predetermined fabrication operations on the workpiece. Via the control station 32, a large number of operations and their parameters can be directed, including, but not limited to, the movement of the gantry assembly 12 including the transverse movement of the bridge 18 along the first and second support members 14, 16, the movement of the carriage 24 along the bridge 18, the vertical actuation of the carriage 24, the rotational movement of the spindle 28/cutting blade 25, the rotational speed of the spindle 28/the cutting blade 25, etc. The inventive aspects of the present disclosure may also be used on non-computerized systems.

As will be described in further detail below, the work table 20 of the CNC routing machine 10 shown in FIGS. 1-3 includes a table top material M having features that are examples of inventive aspects in accordance with the principles of the present disclosure. It should be noted that the CNC routing machine 10 illustrated in FIGS. 1-3 is simply one example machine on which the table top material M having features that are examples of inventive aspects in accordance with the principles of the present disclosure can be used. The use of the table top material M on other machines is possible, and, thus, the embodiments specifically depicted herein should not be used to limit the inventive aspects of the disclosure.

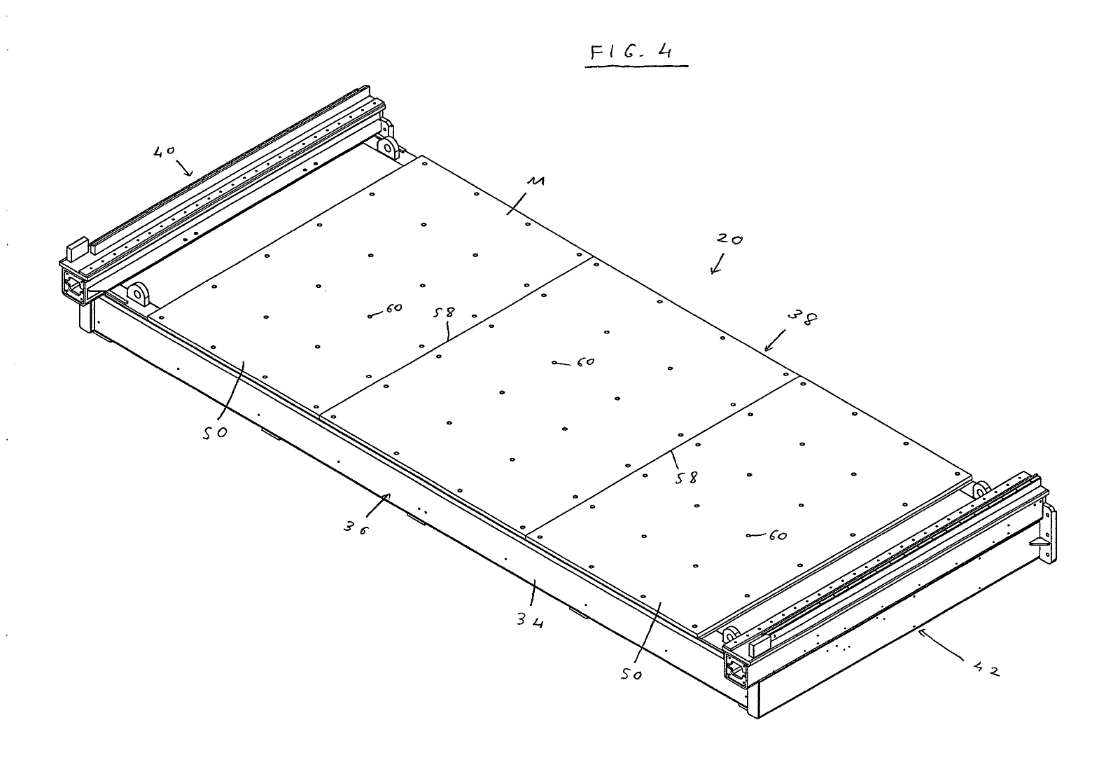

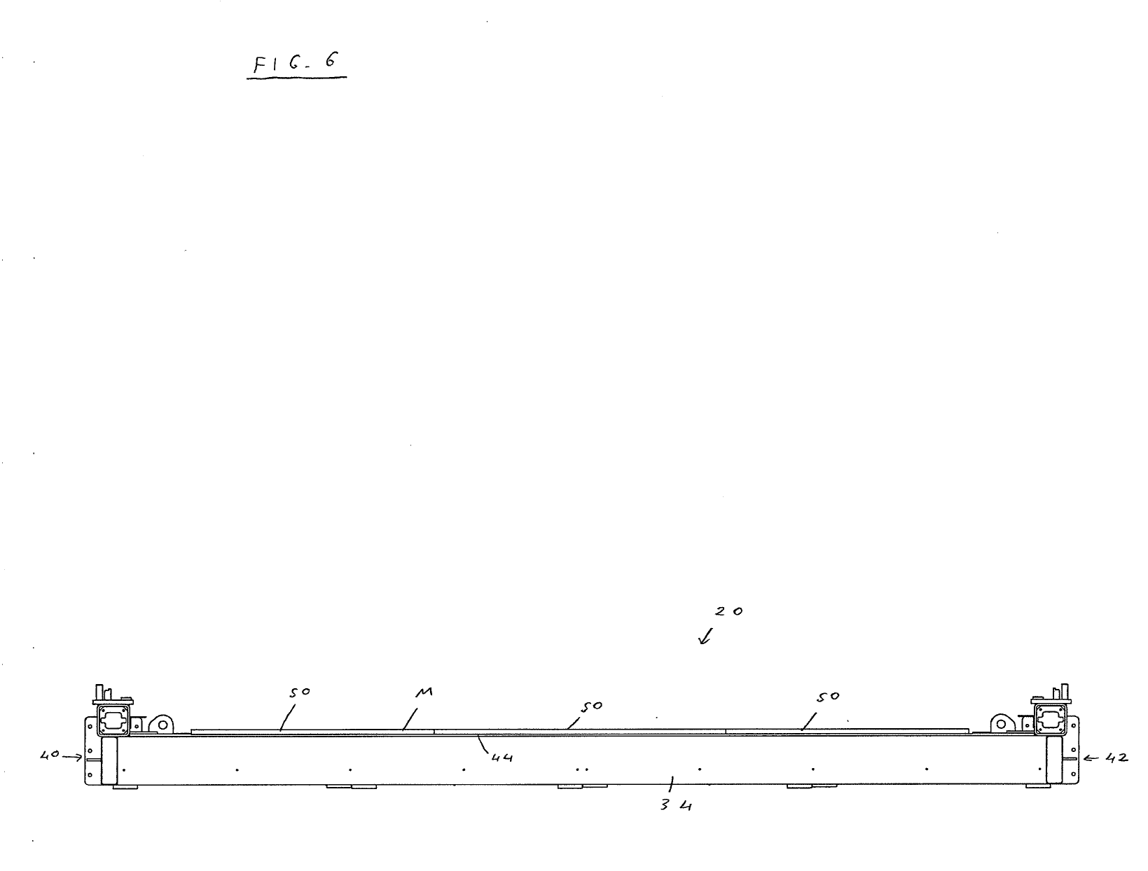

Referring now to FIGS. 4-6, the work table 20 of the CNC routing machine 10 of FIGS. 1-3 is shown in isolation and in closer detail. It should be understood that the work table 20 of the CNC routing machine 10 shown in FIGS. 4-6 is simply one example mounting platform on which the table top material M can be mounted and will also be used to illustrate the mounting method thereof.

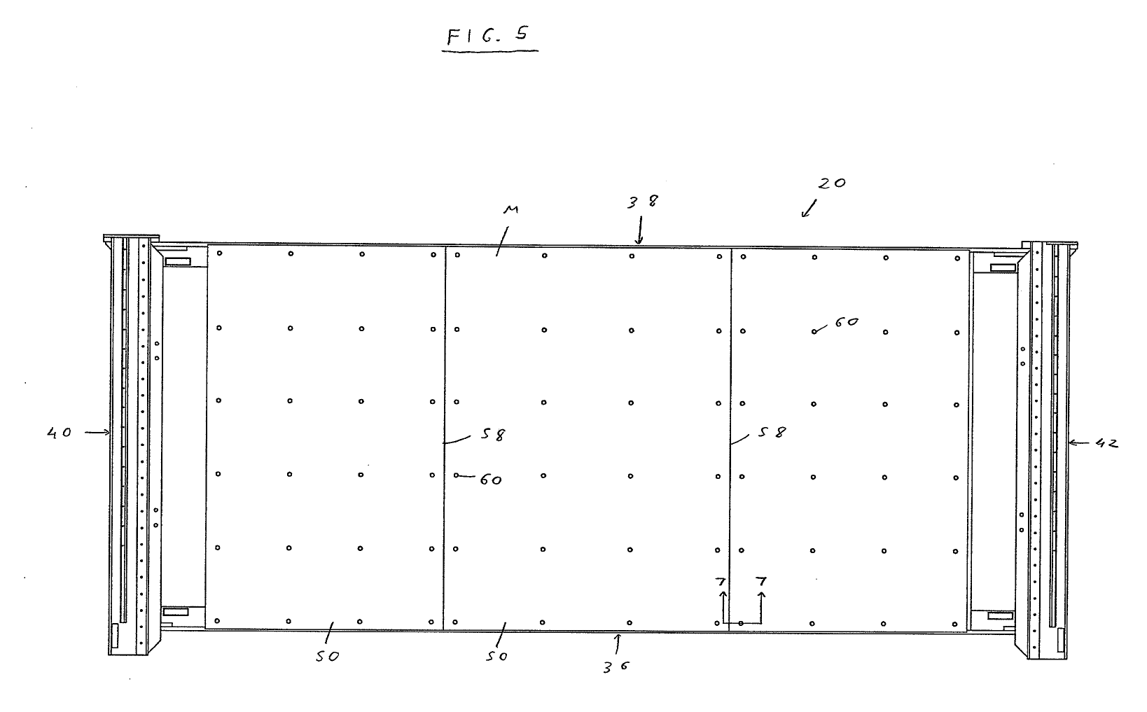

Still referring to FIGS. 4-6, the work table 20 defines a base 34 with a first end 36, a second end 38, a first side 40, and a second side 42. As shown in the depicted example in FIGS. 4-5, the table top is formed from three slabs 50 of material M adjacently mounted on a mounting surface 44 of the base 34 along a direction extending from the first side 40 to the second side 42. Depending upon the layout of the work table, other mounting configurations are also possible.

In accordance with the example inventive aspects of the disclosure, one example table top material M for use on the work table 20 is a combination silicon and epoxy material. According to one embodiment, the material M may include about 70% silicon and about 30% epoxy. One type of silicon/epoxy combination material M suitable for use on the work table is available from Durcon Inc. (Canton, Mich.). Another type of silicon/epoxy combination material M suitable for use on the work table is available from Epoxyn Products L.L.C. (Mountain Home, Ariz.).

The silicon/epoxy combination material M includes certain characteristics and advantages over metals such as aluminum, making the material M better suitable for use as a table top material in the types of machines discussed herein. For example, the silicon/epoxy combination material M does not corrode or oxidize and thus is more durable in aqueous environments. The silicon/epoxy combination material M is chemical resistant and is not likely to be damaged by any additives or flocculant that may be present in water recycling systems. Using the silicon/epoxy combination material M, the seams between the slabs of material M may be sealed so as to maintain a vacuum seal across the seams. With the use of the silicon/epoxy combination material M, scratches or dings may be repaired in the field by filling the damaged areas with the same material, which is not always possible with materials such as metal.

Other advantages of the silicon/epoxy combination material M over different types of metals such as aluminum include a higher static coefficient of friction. This aspect is important in machines utilizing movable bridge and carriage assemblies. The higher static coefficient of friction also provides advantages when using clamping arrangements such as vacuum clamps.

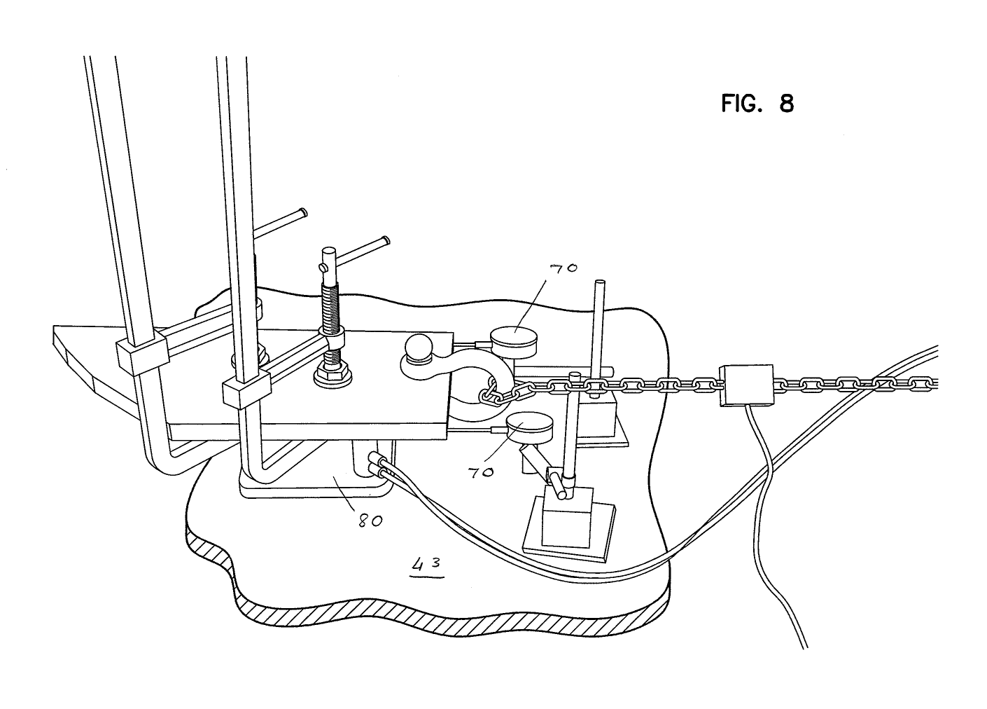

FIG. 8 illustrates an example Pull Test performed to test the static coefficient of friction of various table top materials. The Pull Test illustrated in FIG. 8 and described in further detail below was performed on four different surfaces: 1) Durcon silicon/epoxy combination material (surface finished with a Cobalt/nickel bond diamond tool); 2) Epoxyn silicon/epoxy combination material (surface finished with a Cobalt/nickel bond diamond tool); 3) Epoxyn silicon/epoxy combination material (surface finished with a tool having poly crystalline diamond (PCD) inserts); and 4) K-100S Aluminum.

Dial indicators 70 were positioned to measure movement between the bottom of a vacuum cup 80 and a wet table top surface 43.

The chart below illustrates the results of the Pull Test.

| | Durcon | Epoxyn | Epoxyn | Aluminum |
|---|---|---|---|---|
| | Cutting Tool | | | |
| | Diamond | Diamond | PCD | Carbide |
| Cup Movement | lbs - pull | lbs - pull | lbs - pull | lbs - pull |
| 0.001 | 166 | 160 | 171 | 163 |
| 0.002 | 246 | 260 | 277 | 175 |
| 0.005 | 270 | 286 | 303 | 214 |
| 0.01 | 306 | 320 | 341 | 261 |
| 0.015 | 330 | 349 | 372 | 290 |
| 0.02 | 360 | 375 | 394 | 308 |
| Avg. lbs - pull | 279.667 | 291.667 | 309.667 | 235.1667 |

Illustrated below are also the results of a Coefficient of Friction Test that was performed on the four different wet surfaces listed above. It should be noted that if a body is resting on an incline plane, the body is prevented from sliding down because of the frictional resistance. If the angle of the plane is increased, there will be an angle at which the body begins to slide down the plane. This angle is the angle of response and the tangent of this angle is the same as the coefficient of friction.

| Coefficient of | | |
|---|---|---|
| Friction Test | Response Angle | Coefficient of friction |
| Durcon/diamond | 43 | .9324 |
| Epoxyn/diamond | 43 | .9324 |
| Epoxyn/PCD | 37 | .7535 |
| Aluminum | 34 | .6744 |

It has been noted that the silicon/epoxy combination material M may also provide cost savings over aluminum, the silicon/epoxy combination material M being about 25% of the cost of K-100S aluminum.

Depending upon the features of the machine and features of the work table, the silicon/epoxy combination material M may need some fabrication, as noted in the above tests, before being mounted to a mounting surface of a work table.

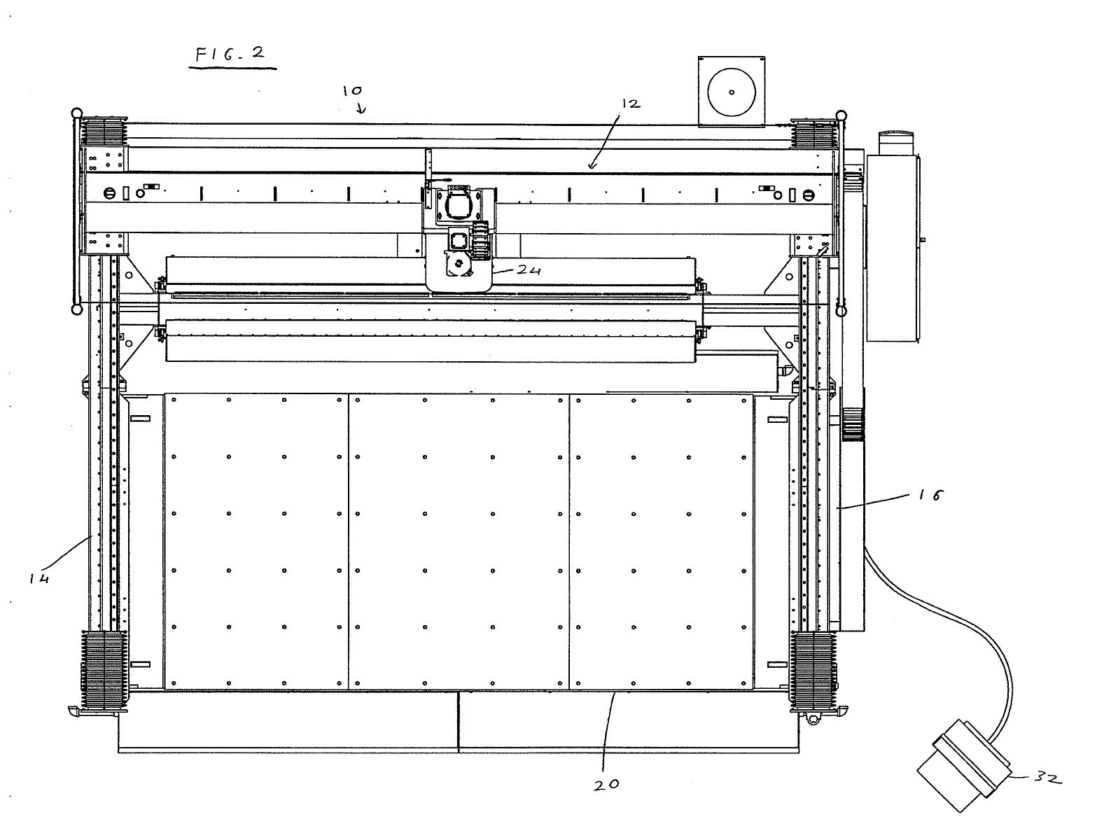

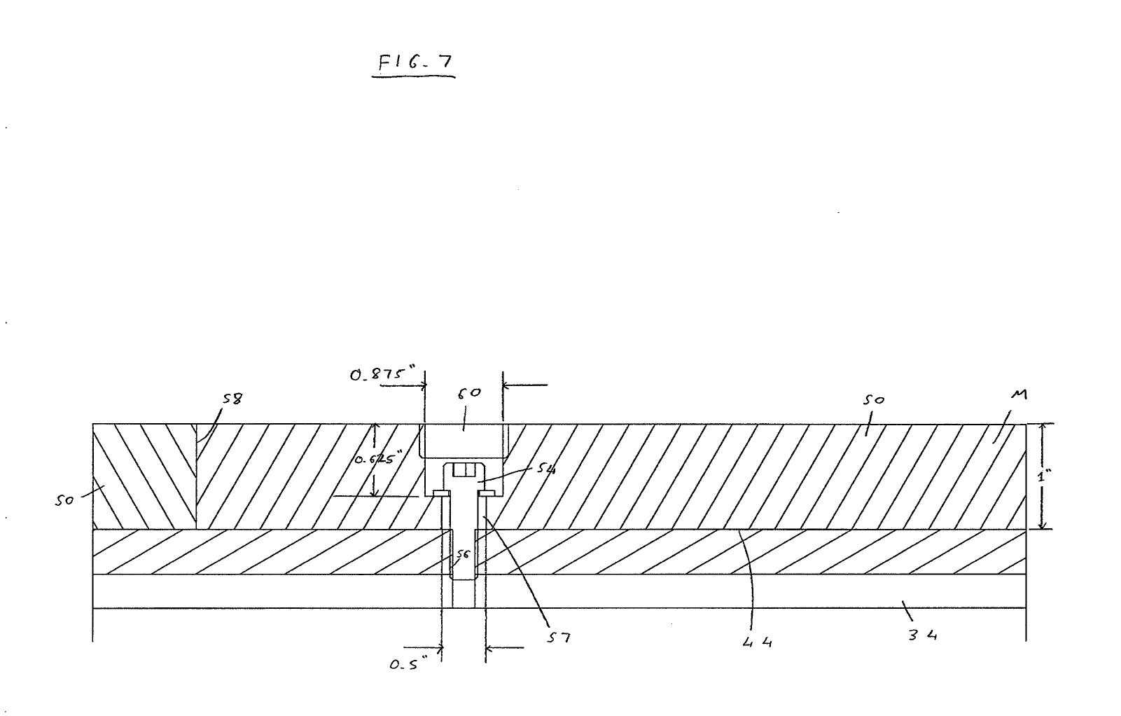

As shown in FIGS. 2, 4, and 5, in the depicted embodiment of the CNC routing machine 10 shown, three slabs 50 of material M are adjacently mounted on the mounting surface 44 of the work table 20. FIG. 7 is a cross-sectional view of a portion of the table 20 of FIGS. 4-6, taken along line 7-7 of FIG. 5. The cross-sectional view of FIG. 7 illustrates an example mounting method for mounting the silicon/epoxy table top material M to the table 20 shown in FIGS. 4-6.

It should be noted that the following description provides for an inventive method of fabricating the silicon/epoxy slabs 50 that is specifically tailored for the work table 20 shown in FIGS. 4-6, which work table 20 is usable on machines such as the CNC routing machine 10 shown in FIGS. 1-3. Depending upon different layouts, arrangements, and fastening techniques, other fabrication methods may be used. The specific examples described should not be used to limit the broad inventive concepts of the present disclosure.

According to one example method shown in FIG. 7, the slabs 50 specified to certain dimensions are stocked. For example, in the embodiment shown in the present disclosure, if silicon/epoxy material available from Epoxyn Products L.L.C. is being utilized for the table top, two 5′×8′×1″ slabs (end slabs) and one 6′×8′×1″ (middle slab) are needed to form the table top. If silicon/epoxy material available from Durcon Inc. is being utilized for the table top, two 5′×8′×1¼ slabs (end slabs) and one 6′×8′×1¼″ (middle slab) are needed to form the table top. The slabs 50 from Durcon Inc. require machining of both faces of the slab 50 as will be discussed below and thus require thicker slabs.

Once a slab specified to required dimensions is obtained, the table top material M is drilled and counterbored. As shown in FIG. 7, according to one example, a ⅞″ core tool may be used for a 0.625″ deep counterbore. After the counterbore step, a ½″ core tool can be used to core through the slab 50. An end mill may be used thereafter to interpolate a 0.8125″ dia. and 0.625″ deep counterbore. This step removes material left between the ⅞″ and ½″ core tools.

Once the appropriate holes 57 are fabricated, the slabs 50 are fastened to the mounting surface 44 of the work table 20 as shown in FIG. 7. Using 5/16″ flat washers, HHCS 5/16″-18NC bolts 54 are torqued at 10-12 ft/lbs with 243 Loc-tite for fastening the slabs 50.

The mounting surface 44 (e.g., of steel) of the work table base 34 includes prefabricated holes 56 for receiving the bolts 54. It will be understood that the silicon/epoxy material M may be used either as a retrofit measure and replace existing table top materials such as aluminum or granite or may be mounted on the work table 20 during initial assembly of the machine 10.

As shown in FIGS. 4-5, each of the slabs 50 may include twenty-four bolts 54 for mounting the slab 50 to the mounting surface 44 of the work table 20. The seams 58 between each of the slabs 50 are glued together at assembly.

A top plug 60 made of PVC polymer or of the same material as the silicon/epoxy material M is friction fit or glued into each of the fabricated holes 57 as shown in FIG. 7. Once the slabs 50 and the plugs 60 are mounted to the work table 20, the CNC routing machine 10 is used to machine and remove a portion of the slab surface facing upward. The removal of the material creates a smooth vacuum surface. The machining may be performed with a cobalt/nickel bond diamond tool at 4500 rpm and at 40″/min feed rate. A thickness of 0.060″ is the recommended max cut.

Since the slabs 50 are placed on the table 20 prior to machining of the vacuum surface and machined by the same machine 10 that will utilize the silicon/epoxy material M as the table top, a substantially perpendicular relationship is obtained between the spindle 28 of the material shaping assembly 26 and the table top.

If silicon/epoxy material M available from Epoxyn Products L.L.C. is being utilized for the table top, the two 5′×8′×1″ slabs (end slabs) and one 6′×8′×1″ (middle slab) are normally mounted face down and only one side of the slabs 50 are machined as described above. It has been found that some impurities may be found after machining 0.030″ off back side. Thus, 0.060″ stock removal to clean up the surface may be required as discussed above. It has been found that during final fabrication of the vacuum surface, a 0.005″ flatness may be achieved under normal operating conditions with two styles of cutting tools. As discussed above, the first cutting tool may be a cobalt/nickel bond diamond tool rotated at 4500 rpm and at 40″/min feed rate, with a thickness of 0.060″ as the recommended max cut. Another possible cutting tool may include PCD (poly crystalline diamond) inserts and rotated at 666 rpm and at 40″/min feed rate with a 0.030″ recommended max cut.

If silicon/epoxy material M available from Durcon Inc. is being utilized for the table top, the slabs 50 from Durcon must be machined on both sides. These slabs 50 are normally mounted face up because of some porosity issues on the back side, even after machining.

Since both sides of the Durcon slabs must be machined and a minimum of 0.060″ stock removal may be required to provide full clean-up of the slab face, Durcon slabs may require the purchase of 1¼″ slabs, rather than 1″ slabs as in Epoxyn.

A cobalt/nickel bond diamond tool at 4500 rpm and at 40″/min feed rate with a 0.060″ recommended max cut may be used to first process the back side of a Durcon slab. Once the holes 57 are drilled and the Durcon slabs are mounted face up, the top face of the Durcon slab 50 is then machined using again a cobalt/nickel bond diamond tool at 4500 rpm and at 40″/min feed rate with a 0.060″ recommended max cut. With a cobalt/nickel bond diamond tool at 4500 rpm and at 40″/min feed rate with a 0.060″ recommended max cut, a 0.005″ flatness can be achieved after machining of the slab 50.

It will be understood that the above described method of fabrication and mounting of the silicon/epoxy material M, including the tools utilized, the parameters specified, the dimensions required, is one example of an inventive method in accordance with the present disclosure. The method described herein is tailored to the specific CNC routing machine 10 shown and described herein and that certain aspects of the method may be modified depending upon features found in different machines.

The above specification provides examples of how certain inventive aspects may be put into practice. It will be appreciated that the inventive aspects can be practiced in other ways than those specifically shown and described herein without departing from the spirit and scope of the inventive aspects.

We claim:

1. A material shaping machine comprising:
a first support member extending generally in a vertical direction;
a second support member extending generally in the vertical direction;
a bridge longitudinally extending between the first and the second support members;
a carriage movably mounted on the bridge, the carriage configured to move longitudinally along the bridge;
a rotary cutting tool mounted on the carriage;
a work table including a table top, wherein the material forming the table top includes a combination of silicon and epoxy;
an actuator for moving the rotary cutting tool toward and away from a workpiece positioned on or above the table top; and
a motor for providing rotational motion to the rotary cutting tool.

2. A material shaping machine according to claim 1, wherein the rotary cutting tool includes a cutting blade.

3. A material shaping machine according to claim 1, wherein the rotary cutting tool includes a router.

4. A material shaping machine according to claim 1, wherein the material forming the table top includes about 70% silicon and 30% epoxy.

5. A material shaping machine according to claim 1, wherein the bridge is configured to move transversely along the first and second support members, the transverse direction being perpendicular to the longitudinal direction.

6. A method of mounting a table top to a work table of a material shaping machine, the material shaping machine including first and second support members extending generally in a vertical direction, a bridge longitudinally extending between the first and the second support members, a carriage configured to move longitudinally along the bridge, the carriage including a spindle extending in the vertical direction, and a rotary cutting tool mounted on the spindle of the carriage, the method comprising:
providing a slab of material having a top surface and a bottom surface, the material including a combination of silicon and epoxy, the slab of material configured to form the table top;
fabricating fastener holes through the slab of material;
mounting the slab of material to a mounting surface of the work table with fasteners through the fastener holes; and
using the rotary cutting tool of the material shaping machine to remove at least a portion of the top surface of the slab of material to provide a perpendicular relationship between the spindle and the table top formed from the slab of material.

7. A method according to claim 6, wherein fabricating the fastener holes through the slab of material includes drilling and counterboring the holes.

8. A method according to claim 6, wherein the entire top surface of the slab of material is removed using the rotary cutting tool in forming the table top of the work table.

9. A method according to claim 6, wherein the rotary cutting tool includes diamond material.

10. A method according to claim 6, further comprising covering the fastener holes with plugs prior to removing at least a portion of the top surface of the slab of material, the plugs being of the same material as the slab.

11. A method according to claim 6, wherein the material forming the table top includes about 70% silicon and 30% epoxy.

12. A method according to claim 6, further comprising mounting a plurality of the slabs of material in a side-by-side orientation prior to removing at least a portion of the top surfaces of each of the slabs in forming the table top of the work table.

13. A method according to claim 6, further comprising removing a preexisting table top from the work table of the machine prior to mounting the table top comprising the silicon/epoxy combination material.

14. A work table for a material shaping machine including first and second support members extending generally in a vertical direction, a bridge longitudinally extending between the first and the second support members, a carriage configured to move longitudinally along the bridge, and a rotary cutting tool mounted on the carriage, the work table comprising:
a base with a first end, a second end, a first side, and a second side;
a slab fastened to a mounting surface of the base, the slab formed of a material including a combination of silicon and epoxy;
a first rail member adjacent the first end extending from the first side to the second side of the base, the first rail member forming at least a portion of the first support member of the material shaping machine, the first rail member configured for moving the bridge transversely in a direction extending from the first side to the second side; and
a second rail member adjacent the second end extending from the first side to the second side of the base, the second rail member forming at least a portion of the second support member of the material shaping machine, the second rail member configured to cooperate with the first rail member for moving the bridge transversely in a direction extending from the first side to the second side.

15. A work table according to claim 14, wherein the material forming the slab includes about 70% silicon and 30% epoxy.

16. A work table according to claim 14, further comprising a plurality of the slabs fastened to the mounting surface of the base, the slabs stacked adjacently along a direction extending from the first end to the second end, each of the slabs being formed of a material including a combination of silicon and epoxy.
